(19) United States
(12) Patent Application Publication
(10) Pub. No.: US 2004/0078814 A1
(43) Pub. Date: Apr. 22, 2004

(54) Module-based interactive television ticker

(75) Inventor: Paul G. Allen, Mercer Island, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: digeo, inc., Kirkland, WA

(21) Appl. No.: 10/112,580

(22) Filed: Mar. 29, 2002

(51) Int. Cl. H04N 7/173; H04N 7/16; G06F 13/00; H04N 5/445; G06F 3/00

(52) U.S. Cl. 725/47; 348/563; 725/44; 725/135; 725/40; 725/113; 725/136

(57) ABSTRACT

A module-based ticker for an interactive television system comprises one or more modules of content that the user can select for presentation. Separate modules of the ticker are selected for sports, news, weather, email, traffic, interactive applications, movies, and so forth. A viewer or user can also customize the ticker by choosing the shape, location, size, appearance, and content of the modules. Three-dimensional modules can scroll ticker information on its surfaces by rotating in the ticker. The content from each of the modules concurrently scroll in the ticker, thereby giving somewhat of an appearance of “a ticker having many tickers.” The modules can be “skins” that have preset or customizable layouts, colors, fonts, borders, shapes, etc. An interactive television service provider or other party can build the skins, and then via upload, make the skins accessible to and selectable by viewers for customization and inclusion into their ticker.

### BACKGROUND OF THE INVENTION

1. Field of the Invention

This disclosure relates generally to presentation of information on a display device, and in particular but not exclusively, relates to an interactive television “ticker” having user-selectable content modules.

2. Description of the Related Art

It is relatively common to see television programs accompanied by a scrolling “ticker.” The term “ticker” derives from the fact that information in the ticker scrolls sequentially across the bottom of a television screen in a manner analogous to a stock market ticker tape. However, instead of simply including stock market information, current tickers carry a wide variety of other types of information. For instance, tickers that are present on sports channels typically scroll game scores or game schedules. Tickers that are present on news channels scroll the latest headlines, weather reports, or brief news updates.

Tickers are generally encoded in the same analog or digital signal as the television signal. For instance, with Motion Pictures Experts Group (MPEG) digital encoding, the ticker information is included along with the MPEG stream. A graphics generator or other mechanism generates the ticker information at a production studio (or other location) and then combines the ticker information with the television signal. The television signal is then broadcast to viewers. Obviously, with this current implementation, viewers have no control over the content of the ticker that is displayed on their television set-what they see is what they get, since the production studio maintains control over what is to be shown in the ticker and when.

Because of this abbreviated information, viewers share common frustrations with tickers. For example, some viewers are interested in only a few items scrolled in a ticker, and therefore, they would rather view more detail related to these items and less information scrolled about other items. For other viewers, current tickers are completely absent of any information for items of interest. For yet other viewers, the information presented in a ticker is too small in size and inconvenient to read or locate, distracts from the television program viewing experience, or is dull and uninteresting in the manner of presentation.

Since the production studio typically has to target the content of their tickers towards a general audience rather than a specific audience segment, it is impractical for the production studio to provide detailed information along with each and every possible ticker item to ensure that all viewer interests are taken into account. Scrolling large amounts of detailed information for all possible topics (or even presenting abbreviated information for all possible topics) is counterproductive to the primary purpose of tickers: providing a quick and convenient mechanism to disseminate tidbits of key information. Instead, the production studio often takes its best “guess” as to which ticker items may be of interest to a sufficiently large group of viewers.

Obviously then, there will always be some group of viewers that will be dissatisfied with the information provided (or not provided) by current tickers. Viewer dissatisfaction can affect the overall success of a service provider, production studio, or other party involved with providing services for the end user. One adverse result of viewer dissatisfaction is lost of “stickiness” for the television service: viewers will not be inclined to remain with any particular service provider since they can get at least the same level of service quality from other service providers, without necessarily sacrificing the familiarity, convenience, or other user-specific benefits present with their current service provider.

### BRIEF DESCRIPTION OF THE SEVERAL VIEWS OF THE DRAWING(S)

Non-limiting and non-exhaustive embodiments of the present invention are described with reference to the following figures, wherein like reference numerals refer to like parts throughout the various views unless otherwise specified.

FIG. 1 is a block diagram of an example interactive video casting system that can implement a module-based ticker in accordance with an embodiment of the invention.

FIG. 2 is a block diagram illustrating example components that can be included in the system of FIG. 1 to provide a module-based ticker in accordance with an embodiment of the invention.

FIG. 3 is a block diagram of an embodiment of a client terminal that can be used in the system of FIG. 1 to present a module-based ticker.

FIG. 4 is an example screen shot in combination with a remote control for implementing one embodiment of the invention.

FIG. 5 conceptually illustrates division of a display screen into regions for presenting modules of a ticker in accordance with an embodiment of the invention.

FIG. 6 is a screen shot showing an embodiment of a module-based ticker.

FIG. 7 illustrates example sizes of modules of a ticker in accordance with an embodiment of the invention.

FIG. 8 illustrates example shapes of modules of a ticker in accordance with an embodiment of the invention.

FIG. 9 illustrates example three-dimensional modules of a ticker in accordance with an embodiment of the invention.

FIGS. 10-12 illustrate examples of content for modules of a ticker in accordance with an embodiment of the invention.

FIGS. 13-14 are screen shots showing other embodiments of a module-based ticker.

FIG. 15 are example user preferences screens that can be used to select and customize modules for a ticker in accordance with an embodiment of the invention.

FIG. 16 is a flow block diagram illustrating components that can interact to present a module-based ticker according to an embodiment of the invention.

### DETAILED DESCRIPTION

Embodiments of a module-based ticker for interactive television are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Moreover, the term “ticker” as used herein is intended to generally describe a presentation of information on a display screen, such as a display screen for a television, and is not intended to be limited solely to implementations where the information is presented in a manner to exactly mimic a stock market ticker. In one embodiment, the ticker can comprise text and graphics that are scrolled or otherwise presented in a region of the display screen, along with a television image (such as an image from a live broadcast or from a recorded program). Various embodiments will be described herein in the context of “scrolling” the ticker information. It is to be appreciated that the term “scrolling” is merely illustrative of a technique to present dynamic ticker information, and that this term, in some embodiments, can encompass implementations where the ticker information is presented via screen segments of information, text segments, one-line-at-a-time, one-sentence-at-a-time, one-word-at-a-time, and the like, rather than the traditional format of one-character-at-a-time typically associated with stock market tickers. Moreover, the term “scrolling” is used generically herein to refer not only to vertical movement from bottom to top, but also movement from right to left (often referred to as “crawl”) or movement in other directions.

As an overview, an embodiment of the invention provides a ticker that can be implemented in a television system, such as an interactive television system. The ticker is module-based in that the ticker comprises one or more modules of content that the user can select for presentation. For instance, separate modules of the ticker can present content for sports, news, weather, email, traffic, interactive applications, movies, and so forth. A viewer or user can customize the ticker by choosing the shape, location, size, and content of the modules (as well as being able to customize other features of the modules).

Accordingly, an embodiment of the module-based ticker provides a larger and more full-featured form of a ticker, where a television program image can occupy a much larger portion of a display screen, while the modules of the ticker occupy space on the display screen that may have been previously unused. The viewer can pick commonly used sources of content for each of the modules (e.g., “favorites”) as preferences, and then have content from each of the modules concurrently scrolling, thereby giving somewhat of an appearance of “a ticker having many tickers.” According to various embodiments, the content of the modules can scroll according to a fixed cycle, or only when updated content is to be displayed. Supplemental content providing greater details of the scrolled content/items can also be scrolled, accessed via links, or presented on a page (such as in a pop-up window). Thus, the viewer is provided with a side-by-side experience between web content and television, and can follow links to additional information via presses on a remote control button.

In an embodiment, the modules can be embodied as “skins” or other graphical user interface that have preset or customizable layouts, colors, fonts, borders, shapes, etc. An interactive television service provider or other party can build the skins, and then make the skins accessible to and selectable by viewers for customization and inclusion into their tickers.

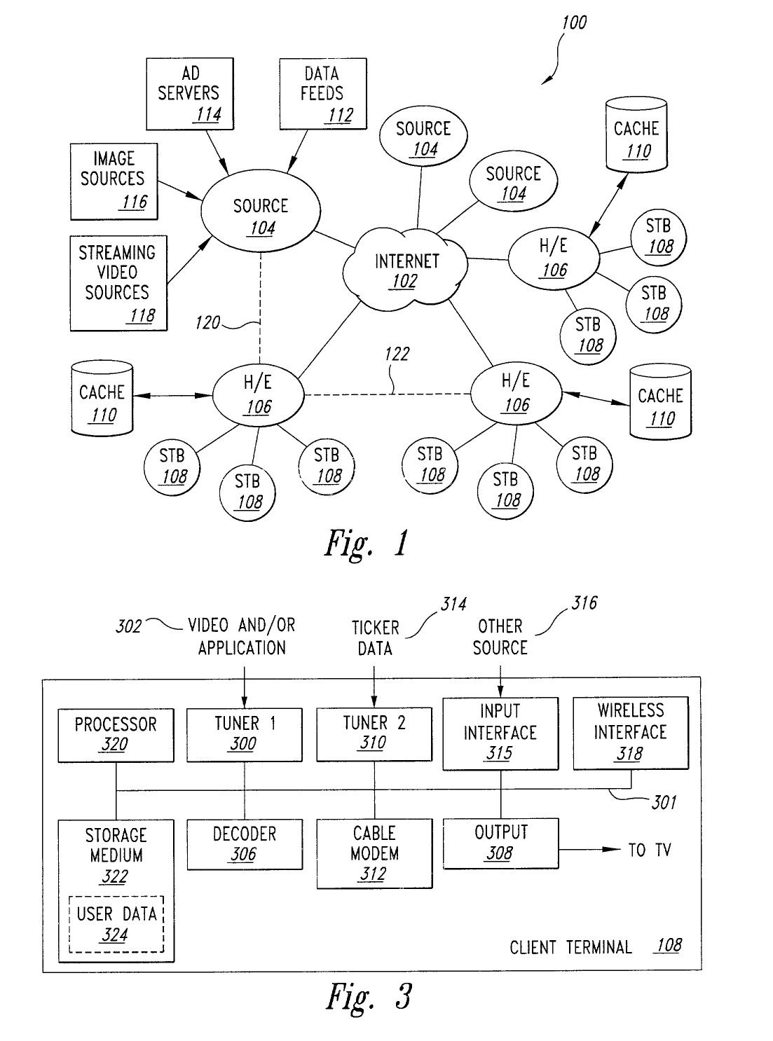

FIG. 1 shows an example of an interactive video casting system 100 for distributing ticker content, Internet content, and television content according to an embodiment of the invention. In accordance with an embodiment of the present invention, the system 100 can be integrated with a cable television distribution system to provide interactive television tickers. The system 100 includes an Internet 102, a plurality of content sources 104, a plurality of distribution centers (depicted as the head-ends or H/Es 106), and a plurality of client terminals 108 (depicted as set top boxes). In addition, a content source 104 is depicted as receiving data from data feeds 112, advertisement servers 114, image sources 116, and streaming video sources 118. The content source 104 may also receive content from a broadcast video source. For the sake of clarity and to avoid clutter, not all of these sources are shown in FIG. 1 for each content source 104.

The plurality of content sources 104 is coupled to the Internet 102. For example, a content source 104 may comprise a web site portal such as Go2Net.com™, or a news web site such as CNN.com™, or other types of sources. Each content source 104 may have various data feeds 112, servers 114, and sources 116/118 coupled to it.

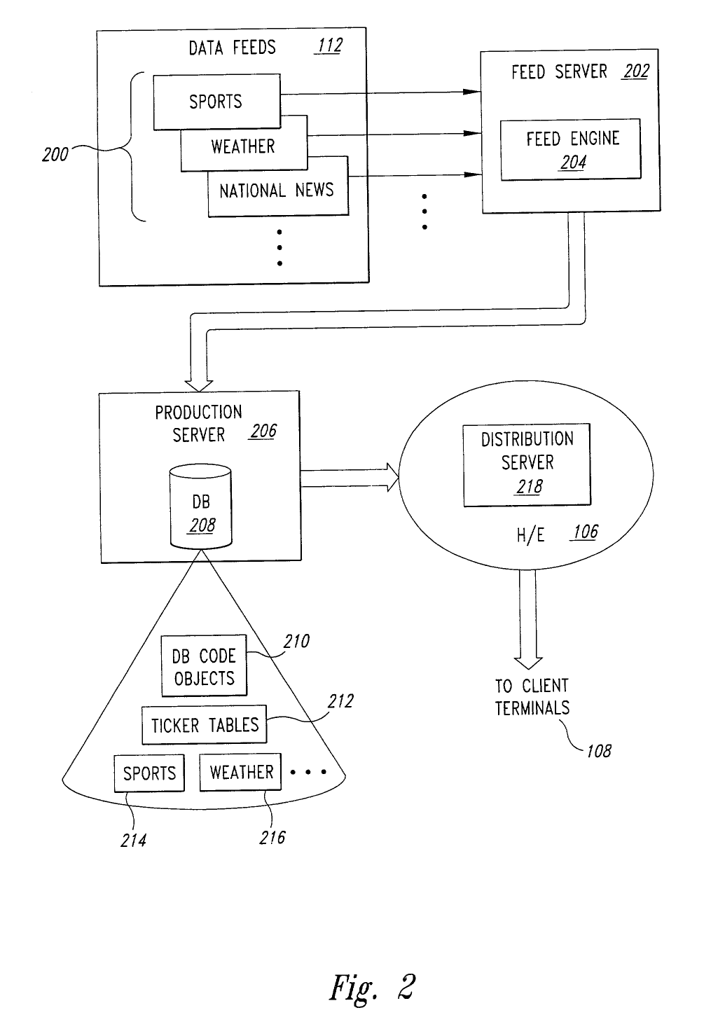

For example, news or stock quote feeds 112 (including data for tickers) may be fed into the content source 104. Servers 114 may provide advertisements for insertion into multimedia content delivered by the content source 104. Sources 116 and 118 may provide images 116, streaming video 118, and other content to the content source 104. Various other feeds, servers, and sources may also be coupled to the content source 104 of FIG. 1. An example configuration of components that can be integrated with the system 100 to provide ticker information to client terminals 108 is shown in FIG. 2.

The Internet 102 comprises a network of networks and is well known in the art. Communications over the Internet 102 can be accomplished using standard protocols such as transmission control protocol/internet protocol (TCP/IP), hypertext transfer protocol (HTTP), file transfer protocol (FTP), or other protocols. The Internet 102 is coupled to the plurality of distribution centers 106, and each distribution center 106 is in turn coupled to a plurality of client terminals 108, which may comprise a set top box, a PC, an interactive television set, or another type of communication device or display device.

In alternative or in addition to the Internet 102 being used to distribute multimedia content (including ticker data) from the content sources 104 to distribution centers 106, communications channels or networks 120 (which can include satellite delivery sources/networks) apart from the Internet 102 may couple one or more content sources 104 to one or more distribution centers 106. One example of such an alternate path for communications is illustrated by a first dashed line 120 in FIG. 1. Alternately or additionally, peering connections may exist between distribution centers 106. One example of such peering is illustrated by a second dashed line 122 in FIG. 1. Other communications configurations are also possible and are included within the scope of the present invention.

Caches 110 may be provided at (or otherwise coupled to) the distribution centers 106. Such caches 110 may be used to increase the performance in the delivery of multimedia content (including ticker data or skins) to the client terminals 108. For example, larger files for video and other high bandwidth content may be stored in such caches 110, which may be closer-in-time to the client terminals 108 than to the content sources 104. In addition, reliability and guaranteed bandwidth may be provided because the Internet 102 is not in-between such caches 110 and the client terminals 108. In one embodiment, the caches 110 or other storage media in the system 100 can store ticker information, rather than or in addition to having such information buffered, cached, or otherwise stored at the client side.

In an embodiment, servers may be present in the distribution centers 106, with such servers including or being coupled to the caches 110 or other storage media. Alternatively or in addition, these servers may be located remotely from but still communicatively coupled to the distribution centers 106, via the Internet 102 or other communications channels or networks. Examples of such servers that can be used in connection with providing ticker information to client terminals 108 are shown in FIG. 2.

In accordance with one embodiment of the invention, different or multiple portals may be used to access the information provided through the interactive video casting systems of FIG. 1, based on the type of client terminal being used by the end user. That is, for example, a television portal may be provided for an end user that uses a television set coupled to the client terminal 108 to access the information. A PC portal may be provided for an end user that uses a PC to access the information. Portals can be provided for end users that use cellular telephones, personal digital assistants (PDAs), audio devices, and the like to access the interactive video casting system 100 of FIG. 1.

Such portals may be provided in several possible ways. In one embodiment, the client terminal (e.g., the end user's display device or audio device) can be suitably configured with an adapter that includes hardware and software. The adapter converts the television signals, the Internet or web page content, or other information provided from the interactive video casting system into a digitized format or other format that is compatible with the operational features of the particular client terminal 108.

In another embodiment, a cable service provider can deliver signals having different formats to the various client terminals 108, with the client terminals not necessarily having special adapters. Therefore, as an example, the cable service provider or other party can generate/deliver information (e.g., television programming, web page content, ticker information, and the like) having a format that is compatible for end users that receive the information via a television set. The cable service provider or other party can also generate/deliver the same information (e.g., simultaneously with the television portal on the same communication link, separately on a different communication link, on-demand independent of the television portal, and the like) using a format that is compatible with end users that receive the information via PCs, PDAs, cellular telephones, and the like. Thus, the term “interactive video casting system” is used to describe generally a system that can deliver video information and other information over any network and any network-compatible device by broadcasting, multicasting, or unicasting. An “interactive television system” is one type of or one means of access to an “interactive video casting system.”

FIG. 2 is a block diagram illustrating example components that can be included in the system 100 of FIG. 1 to provide data for tickers in accordance with an embodiment of the invention. The data feeds 112 include a plurality of different ticker data feeds 200 that provide a variety of different topical data that can be displayed in a ticker. For instance, the different ticker data can include sports data, weather data, national news, and so forth. The sources that can provide this data can include entities such as Reuters™, The Sporting News™ (TSN), Associated Press™ (AP™), and others. In one embodiment, the ticker data from the data feeds 200 comprises “raw” unformatted data (e.g., data with minimal or no formatting or graphics).

The raw ticker data is provided to a feed server 202. In an embodiment, the feed server 202 operates as a content aggregator that pulls or otherwise receives the raw ticker data from the data feeds 200. The feed server 202 also performs data manipulation on the received ticker data to manipulate the data into a database format so that the data can be indexed and stored. A feed engine 204, which can be embodied in software or other machine-readable instructions stored on one or more machine-readable media according to an embodiment, can reside and run in the feed server 202 to perform at least some of this data manipulation.

The feed server 202 is coupled to provide the manipulated ticker data to a production server 206. The production server 206 includes or is otherwise coupled to a database 208. The feed engine 204 calls on the database 208, and instructs the database 208 where to place the various ticker data. For example, the database 208 can include a plurality of database code objects 210 that cooperate with ticker tables 212 (such as a sports table 214, a weather table 216, and so forth) to index or store ticker data. The feed engine 204 calls the database 208 and identifies the database code objects and ticker tables where the ticker data is to be stored.

The various components of the database 208, such as the ticker tables 212, can also be configured in a manner that optimizes the organization and distribution of the ticker data. For example, ticker data unique to various geographic regions can be segregated from or otherwise identifiable from each other, so that ticker data that is relevant to only particular client terminals 108 need not be broadcast to all client terminals. For instance, California weather information can be segregated from Oregon weather information in the database 208 in a manner that client terminals 108 of California users do not receive Oregon weather information, unless specifically requested. This feature improves transmission efficiency and transmission time, since the bandwidth of communication paths to certain client terminals 108 are not clogged by non-relevant ticker data.

In an embodiment, the production server 206 can also perform data manipulation, such as before the data is stored in the database 208, while it is stored in the database 208, or after the data is retrieved from the database 208 for transmission to client terminals 108. For instance, the production server 206 can perform data manipulation to place the ticker data into a format that is “consumable” or otherwise compatible with operating software of the client terminals 108. For instance, the production server 206 can place the ticker data into formats such as hypertext markup language (HTML), extensible markup language (XML), or other suitable formats.

The production server 206 is coupled to provide ticker data from the database 208 to one or more distribution servers 218, which may be located in or otherwise communicatively coupled to a distribution center 106 (such as a head-end). The distribution server 218 operates to provide the ticker data to the client terminals 108 via several possible communication paths or channels, as will be described with reference to FIG. 3.

It is to be appreciated that the components shown in FIG. 2 are merely illustrative of the various components of one embodiment that can be used to provide ticker information. For example, other embodiments can use more or fewer servers, as well as different components, to perform the various operations. Moreover, the various servers and their components (such as the feed engine 204 and the database 208) can be distributed elsewhere in the system 100, instead of or in addition to the locations shown in FIG. 2. There may be multiple feed servers 202, production servers 206 and databases 208, distribution servers 218, and so on to account for load balancing, redundancy in case of outages or broken connections, and other factors that can affect distribution of ticker information.

FIG. 3 is a block diagram of an embodiment of a client terminal 108 for the system 100 of FIG. 1 that can implement an embodiment of the invention to present a module-based ticker. For the sake of simplicity of illustration and explanation, only the components that are germane to understanding an embodiment of the invention are shown in FIG. 3. It is understood that the embodiment of the client terminal 108 shown in FIG. 3 can have other components different than or in addition to what is shown. Moreover, the various illustrated components may be suitably combined in some embodiments, instead of being separate. It also should be noted that the client terminal 108 is only one embodiment of the invention and that some or all of the components described as embodied in the client terminal 108 can be incorporated into a client television rather than in a separate device. A bus 301 is shown symbolically to depict coupling between the various components.

To briefly describe an embodiment, the client terminal 108 receives ticker data from the distribution server 218, and then performs the appropriate processing of the data to allow the data to be displayed in a ticker on a display screen of a television set. The client terminal 108 can be passive in that it receives the ticker data (as well as updates) when the data is sent by the distribution server 218, independently of whether the client terminal 108 requested the ticker data (e.g., the distribution server 218 “pushes” the ticker data to client terminals 108). Alternatively or in addition, the client terminal 108 can poll or otherwise explicitly request the ticker data from the distribution server 218, including polling the distribution server 218 for updated data (e.g., the client terminal 108 “pulls” the ticker data from the distribution server 218). In some embodiments, both push and pull mechanisms may be involved.

Once it receives the ticker data from the distribution server 218, the data can be buffered or cached (if appropriate), and processed for presentation on the display screen of the television set. In an embodiment, ticker software in the client terminal 108 can work in conjunction with a ticker template or other ticker user interface to display the ticker (and its ticker items) in the appropriate scrolling layout, format, locations, time intervals, topics, content, and so forth. In one embodiment where the ticker data is obtained from the Internet 102, this ticker software can comprise browser-based software or other software capable to cooperate with a web browser. According to various embodiments, the ticker can be generated and made interactive through Flash, C++, Java, HTML, or other suitable code or software.

The client terminal 108 comprises a first tuner 300 to tune to a Moving Pictures Experts Group (MPEG) stream 302 or other video source. The stream 302 may include video, live transmission, and/or application code, including corresponding text and graphic resources. In an embodiment where tickers are provided in an integrated manner along with the video signal, the ticker can be received by way of the stream 302. One skilled in the art will recognize that there will be a plurality of streams 302, depending on the number of channels and programs that the cable service provider makes available to the client terminal 108.

The first tuner 300 is coupled to a decoder 306 that decodes the video, application, and/or audio into a format that is compatible with a television set coupled to the client terminal 108. The client terminal 108 may include a second tuner 310. The second tuner 310 can work in conjunction with a cable modem 312 to obtain ticker data 314 from the Internet 102, such as via a Data Over Cable Service Interface Specifications (DOCSIS) connection with the distribution server 218. In addition to the ticker data 314, Internet content can also be received by the client terminal 108 by way of the DOCSIS connection through the second tuner 310 and the cable modem 312. In one embodiment, the second tuner 310 can be used to obtain video or other supplemental information stored at a server (such as a video-on-demand server located at a distribution center 106), remote database, Internet location or web site, or other source depicted in FIG. 1.

In addition, the client terminal 108 includes or is coupled to an input interface 315, through which other sources 316 of ticker data can be provided to the client terminal 108. An example of the input interface 315 comprises an out-of-band tuner that can be used to tune to ticker data that is provided from the distribution server 218 via an out-of-band channel. In an embodiment, the out-of-band channel(s) can comprise one or more low-bandwidth frequencies carried on the same coaxial cable used to provide the MPEG streams and the Internet content. The out-of-band channel(s) tuned to by the input interface 315 to receive ticker data can be used alternatively or in addition to the DOCSIS channel tuned to by the second tuner 310 in such an embodiment. In one embodiment, video or other supplemental information may be communicated to and from the client terminal 108 via the input interface 315.

Further alternatively or in addition, the input interface 315 can comprise another television broadcast tuner (such as the first tuner 300) to tune to one or more channels that may be carrying ticker data. For example, ticker data (including updates) may be broadcast in one or more channel frequencies specifically dedicated for transmission of ticker data to client terminals 108. Thus, as an illustration, the first tuner 300 can tune to a channel showing a television program, while the input interface 315 is tuned to receive ticker data (in the form of packets, for example) from a ticker channel to allow a ticker to be simultaneously shown on the same television screen as the television program. Alternatively or in addition to ticker data, the input interface 315 may be used to tune to a channel that provides video highlights or other information for a ticker.

Yet another example of the input interface 315 is an interface to receive outputs of recording devices such as a PVR or a digital video recorder (DVR) that may have ticker data, video, or other supplemental information stored therein, which may be received via download. Alternatively or in addition, the input interface 315 can comprise a communication interface, such as an Ethernet connection, a digital subscriber line modem, a wireless communication interface, and so forth, which can provide a link to the server 218 to receive ticker data, video, or other supplemental information, for instance.

An embodiment of the client terminal 108 may include a processor 320 to control operation of the various components shown in FIG. 3. The processor 320 may work in conjunction with ticker software or other machine-readable instructions stored on at least one machine-readable storage medium 322. Such ticker software may cooperate with the processor 320 to present ticker data in a ticker template or other screen interface or user interface, configure the format and layout of the ticker displayed on the display screen of the television, process received user commands related to configuring content modules, obtaining ticker data (and related supplemental information) from the distribution server 218 or other source, and other operations. In an embodiment, the ticker software can be pre-installed in the client terminal 108. In another embodiment, the ticker software may be installed by way of download from the system 100.

An audio and video output subsection 308 of the client terminal 108 receives decoded video and/or other applications (including ticker templates and the ticker data presented therein or supplemental ticker information), and provides the decoded information to a television set. A wireless interface 318 operates to receive commands from a user input device (such as a wireless remote control). Such commands can include user commands to view a video or other supplemental content related to a displayed ticker item, in an embodiment. The wireless interface 318 provides these commands to the processor 320 so that the processor 320 can cooperate with the ticker software to perform the corresponding operation.

In an embodiment of the invention, the storage medium 322 can also store user data 324 related to operation of the ticker. For instance, the user data 324 can include user settings related to selection, arrangement, and configuration of content modules. In any of these storage locations, multiple sets of user data 324 may be stored, such as in implementations where multiple users in a household log into a same client terminal 108.

The storage medium 322 can include cache(s), buffer(s), or other types of storage locations where ticker data, module templates or skins for the viewer to choose from, video, or other supplemental information may be stored. For example, received sports scores can be stored in the storage medium and retrieved during the appropriate times during the course of the scrolling of the ticker. The ticker data stored in the storage medium 322 can be replaced as updates are received from the distribution server 218. In one embodiment, less time-dependent ticker information (e.g., information that need not necessarily be updated several times per day), including graphics for weather displays, game schedules, and the like, can be downloaded to the storage medium 322 during non-peak television viewing periods (such as late at night), and then retrieved from the storage medium 322 when that piece of information is appropriate for presentation in the ticker.

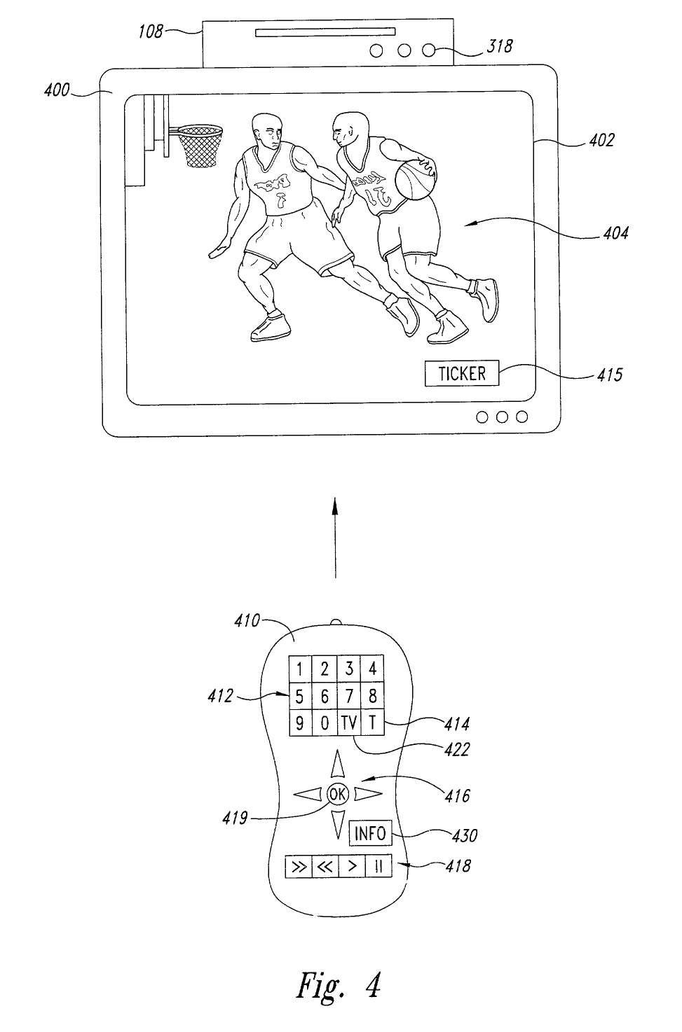

FIG. 4 is first example screen shot (in combination with a remote control 410) depicting implementation of one embodiment of the invention. For simplicity of explanation, not all of the possible module implementations are depicted herein, as such other possible implementations can be ascertained by examination of what is specifically shown in the figures. Moreover, it is to be appreciated that the format, layout, direction, content, and other characteristics of the tickers and modules shown in the figures are merely illustrative and that variations are possible.

In FIG. 4, a television set 400 is coupled to the client terminal 108 in a manner that allows a display screen 402 of the television set to show a television program 404. The television program 404 in this example is a basketball game. A ticker icon 415 can be optionally displayed to alert the viewer that a ticker service is available.

The wireless remote control 410 is in communication with the client terminal 108 (via the wireless interface 318) to perform conventional television-viewing operations and also to control operation of a ticker according to an embodiment of the invention, including navigation, selection of ticker items, and selection and configuration of content modules. The remote control 410 includes an alphanumeric keypad 412 that the viewer can use to select television channels or to enter menu selections. Buttons 418 can comprise buttons that are similar to play, rewind, fast forward, pause, etc. buttons usable for recording devices or for ticker operations. In an embodiment, the remote control 410 can include a ticker button 414, which if pressed in response to presentation of the ticker icon 415, causes a command to be sent to the client terminal 108 to instruct the ticker software to render a ticker on the display screen 402. If the ticker button 414 is pressed again, the ticker is taken off the display screen 402. Alternatively or in addition, a TV button 422 can be pressed to dismiss the ticker. The ticker 600 could be invoked and dismissed via a number of ways—such as by voice command(s), by gesture(s), by touching the ticker screen interface (e.g., touch-screen functionality), or by presence-detect (e.g., sensing a remote control being picked-up), among others. It is to be appreciated that the scope of the invention is not limited by the particular type of technique to invoke and dismiss the ticker 600.

FIG. 5 conceptually illustrates division of the display screen 402 into regions 500 for presenting modules of a ticker in accordance with an embodiment of the invention. More specifically, the display screen 402 can be symbolically characterized as having a total usable display area defined by the regions 500. Any individual region or combination thereof may be used to present a television program image or content modules of a ticker. For example, regions 502-524 can be used to display the television program 404, while the remaining regions adjacent to the regions 502-524 can be used to display a ticker and its modules.

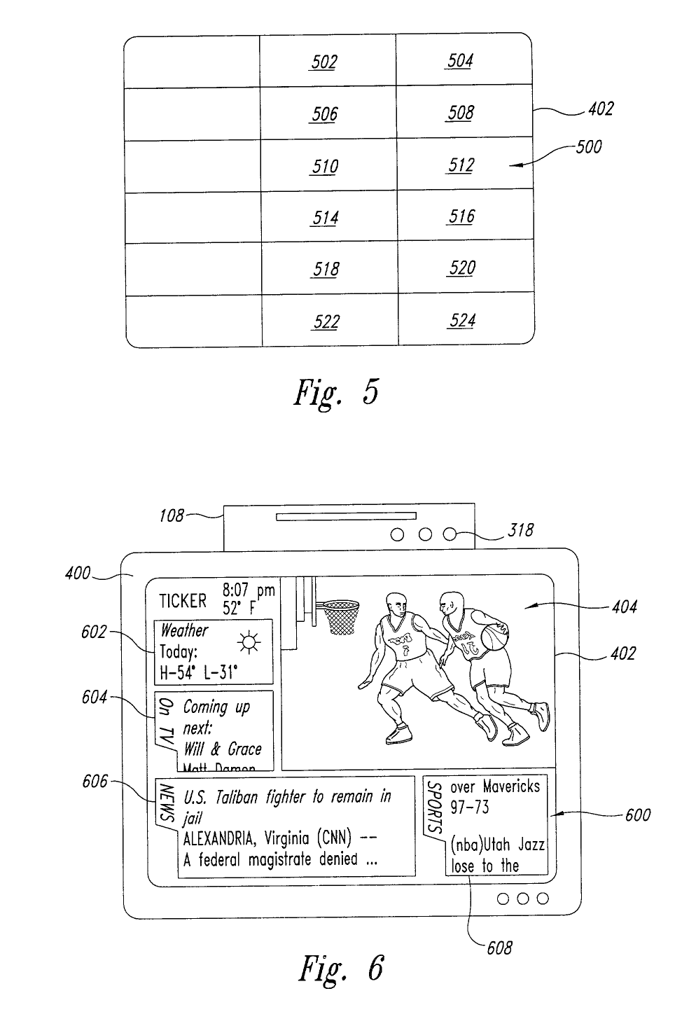

FIG. 6 is a screen shot showing an embodiment of a module-based ticker 600 displayed on the display screen 402. As shown, the image of the television program 404 has been scaled down in size so as to allow concurrent presentation of the ticker 600. Although the television program 404 is depicted in FIG. 6 as occupying the upper right region of the display screen 402, it is to be appreciated that the television program 404 can be displayed on other regions and in different sizes, according to user customization that will be described later below.

The ticker 600 comprises a plurality of modules 602-606, including a weather module 602, a television guide module 604, a news module 606, and a sports module 608. In an embodiment, the various modules of the ticker 600 can initially be preset in terms of size, content, shape, location, and so forth, then later customized by the viewer. At least some of the modules in the ticker 600 can be constantly scrolling, such as in a bottom to top direction for the television guide module 604 and the sports module 608. In this manner, such modules operate as “individual tickers within the ticker 600,” where the viewer can concurrently view constantly changing ticker items from the same ticker 600 (rather than waiting for a single ticker to sequentially scroll through all topics one at a time).

In an embodiment, at least some of the modules in the ticker 600 can remain stationary, and then scroll only when updated information is becomes available. For instance, the weather module 602 can constantly display the current forecast, and then scroll new data only when the forecast changes.

At least some of the modules in the ticker 600 display only abbreviated information in one embodiment. If the viewer wishes to view detailed supplemental information, then the viewer can navigate to the particular module and then press an INFO button 430 on the remote control 410 to issue a command to present supplemental information. In response to this command, the ticker 600 can present the detailed information within the module, in an adjacent pop-up window, via tuning to another television channel, launching a web page, and so forth. The supplemental information can comprise video (including accompanying audio), text, or a suitable combination of both. The supplemental information can also scroll in a window in one embodiment, or the window can be provided with scroll arrows or “next page” controls. Example embodiments of techniques to present supplemental information along with a ticker are disclosed in U.S. patent application Ser. No. ______, Attorney Docket No. 260042.490 (digeo reference 756), entitled “INTERACTIVE TELEVISION TICKER LINKED TO SUPPLEMENTAL INFORMATION, INCLUDING VIDEO HIGHLIGHTS,” with inventor Paul G. Allen, filed Mar. 26, 2002, and assigned to the same assignee as the present application.

In an embodiment, the viewer can use arrow buttons 416 on the remote control 410 to navigate from one module to another, such as via a movable selection rectangle. In other embodiments, at least some of the modules can include a stationary center focus box. When a scrolling ticker item scrolls into the center focus box, the viewer can press the OK button 419 or other button on the remote control 410 to select that item to obtain supplemental information, for instance.

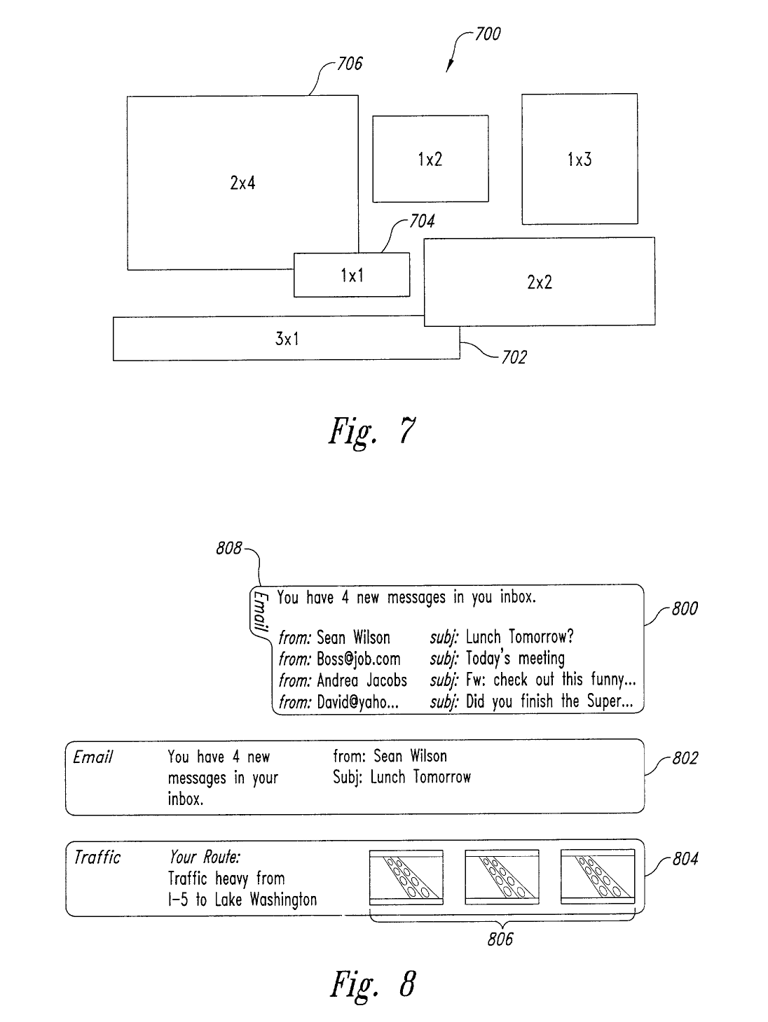

FIG. 7 illustrates example sizes of modules 700 for the ticker 600 in accordance with an embodiment of the invention. In an embodiment, the modules 700 can each have a dimensional width and height (measured in pixels, inches, or other suitable measurement criteria) that can be selected by the viewer. For instance, the viewer may wish to select a module 702 having a 3×1 ratio size for horizontally scrolling stock market information, which is best depicted via a single line of text. Smaller modules (such as a module 704) may be selected to present smaller pieces of information, such the current temperature, while larger modules (such as a module 706) can be used to present more detailed information, like full stories for breaking news. It is to be appreciated that the various modules and their sizes depicted in FIG. 7 are not necessarily drawn accurately or to scale-FIG. 7 is merely intended to illustrate differences in sizes of the modules for the ticker 600.

FIG. 8 illustrates example shapes of modules of the ticker 600 in accordance with an embodiment of the invention. Such example module shapes may be determined in part based on the example sizes illustrated in FIG. 7, and are illustrative of only some of the possible shapes that are available. An email module 800, which can be used to scroll email information in the ticker 600, has a stout rectangular shape so as to able to display information for a plurality of emails (four). This may be useful for a viewer that wishes to see several messages in an inbox, rather than viewing one message at a time. A tab portion 808 gives the email module 800 a distinctive “file card” shape, which adds to its visual treatment as a “snap on” or “add on” module. Example embodiments of a ticker than can provide email capabilities are disclosed in U.S. patent application Ser. No. ______, Attorney Docket No. 260042.488 (digeo reference 720), entitled “INTERACTIVE TELEVISION TICKER INTEGRATED WITH AN APPLICATION, INCLUDING AN EMAIL APPLICATION,” with inventor Paul G. Allen and Michael J. Markman, filed concurrently herewith, and assigned to the same assignee as the present application.

In comparison to the email module 800, an email module 802 has a thinner and less-distinctive shape, such that only one email message at a time can be displayed. This shape for this email module 802 may be desirable to viewers who wish to view only the most recent emails, while only receiving indication in the module that there are more emails in the inbox. A traffic module 804 has a similar shape as the email module 802. An embodiment of the traffic module 804 can present video or photographs 806, along with traffic updates.

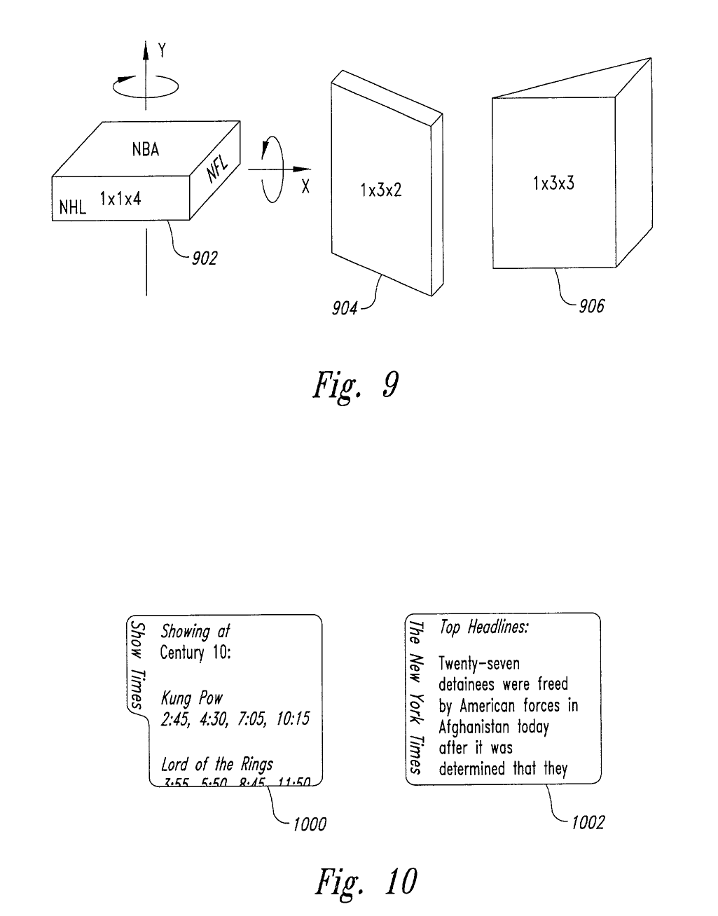

FIG. 9 illustrates example three-dimensional modules 902-906 usable for the ticker 600 in accordance with an embodiment of the invention. Each of the modules includes a plurality of surfaces that can present ticker information. For example, the module 902 can be a sports module having three surfaces that can scroll sports scores from the NHL™, NBA™, and NFL™, respectively. In another example implementation, the module 902 can be devoted to just one sport (such as the NBA™) and then scroll scores from the various basketball games on each of its surfaces.

In an embodiment, the three-dimensional modules 902, 904, and 906 can scroll ticker information via rotation within the screen interface of the ticker 600. That is, as an example, the module 902 can first scroll NHLTM scores on a single surface (such as by scrolling scores sequentially from bottom to top on the same front surface that is currently displayed by the ticker 600). Then, after finishing its scroll of these hockey scores, the module 902 can rotate 90 degrees clockwise about a vertical axis Y so that the surface having the NFL™ scores are now presented to the viewer on the display screen 402. The football scores would then scroll across this surface from bottom to top. The module 902 continues its rotation (including rotation about a horizontal axis X) and scrolling for each subsequent surface, and repeats. In an embodiment where the module 902 is devoted to a single sport, the entire module can rotate constantly in a manner that a separate score is displayed on each surface during each rotation, rather than having individual scores scrolling across a single surface.

Various technologies can be used to give the viewer the appearance of a rotating three-dimensional module within the ticker 600. In one implementation, Flash is used, with “movies” of information being shown on each surface. Moreover, it is to be appreciated that a physical three-dimensional module need not necessarily be defined by the underlying software. Rather, the ticker software can be designed in a manner that current ticker information is always referenced to and displayed in the front face, but the graphical software gives the illusion that the module has rotated in a manner that ticker information was first located at a back or side surface and then physically rotated to the front surface.

FIGS. 10-12 illustrate examples of content for modules usable for the ticker 600 in accordance with an embodiment of the invention. The content of such modules can be selectable by the viewer, based on subject matter topics made available for selection by the interactive service provider, with such modules (and their configuration or format) being selectable from a pool. As with the other modules previously described above, the individual modules shown in FIGS. 10-12 can each individually scroll ticker information, have different shapes and sizes, and can be customized in several respects (such as font size, color, border, theme, location, etc.), and uploadable and accessible by other viewers, if desired.

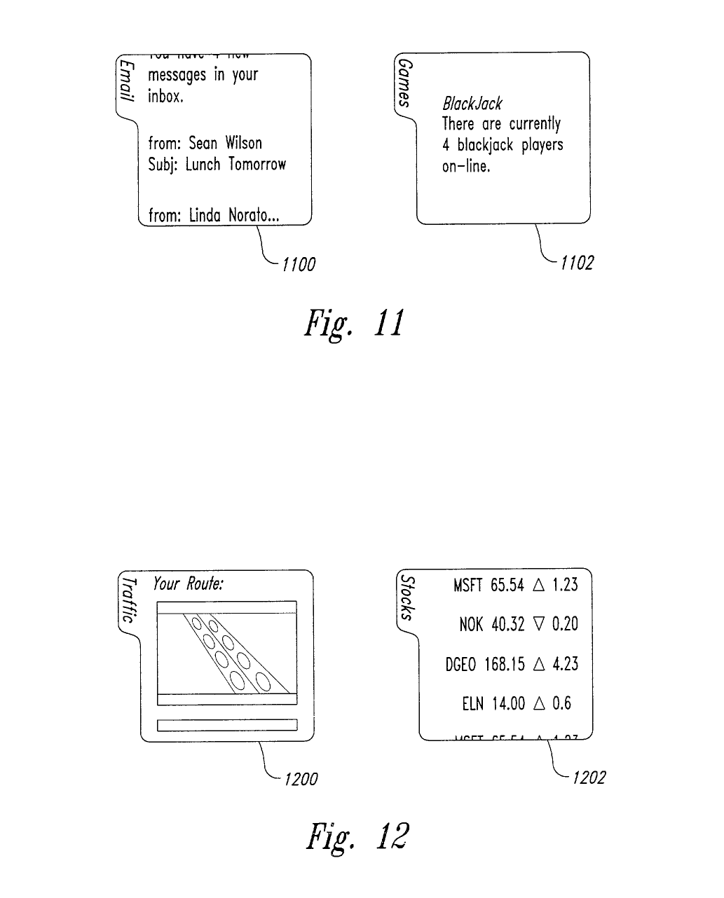

FIG. 10 illustrates a movie module 1000 to provide movie show time and preview information, and a news module 1002 to provide headline news stories. FIG. 11 illustrates two types of modules for interactive services or applications that can be presented in the ticker 600, including an email module 1100 and a games module 1102, both of which may be used by the viewer to interact with other users/viewers. FIG. 12 illustrates a traffic module 1200 and a stock market module 1202, with the traffic module 1200 capable to present a video or photograph of current traffic. The various modules shown in FIGS. 10-12 can be provided with separate data feeds or share a single data feed.

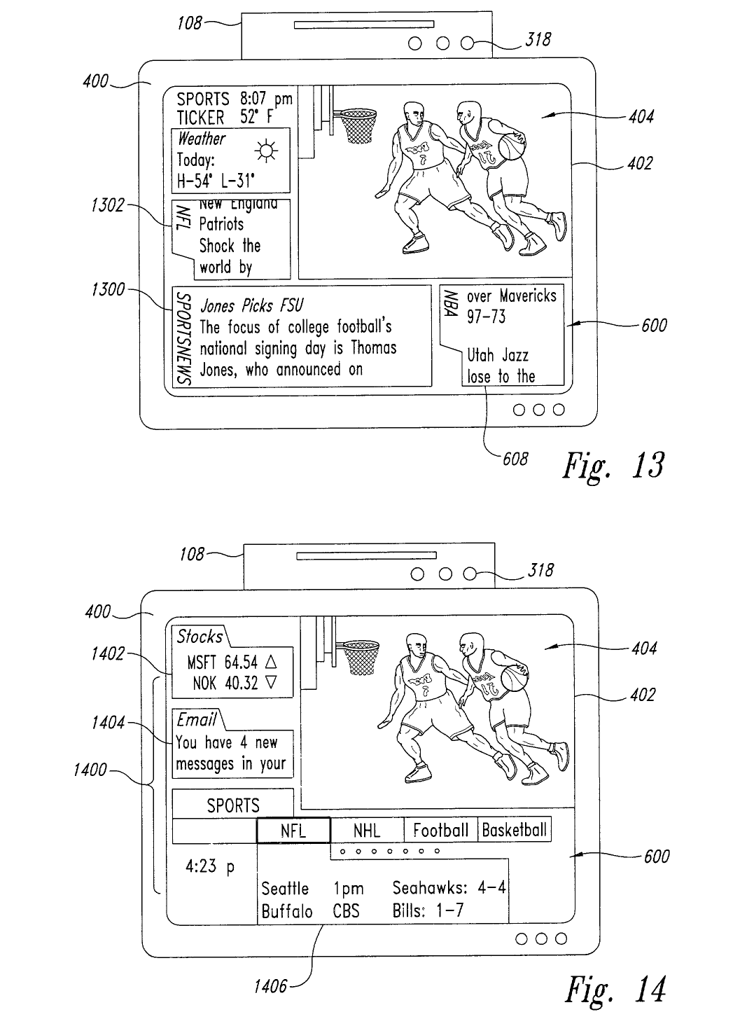

FIGS. 13-14 are screen shots showing other embodiments of the module-based ticker 600, which may result after user customization. In FIG. 13, the viewer has configured the ticker 600 according to a sports theme by selecting modules related to sports. The sports module 608 scrolls basketball game scores. A sports news module 1300 presents sports stories, and an NFL™ module 1302 scrolls football headlines. In an embodiment, the various modules of FIG. 13 can comprise individual skins, while in another embodiment, the entire sports theme of the ticker 600 can comprise a single skin.

Other examples of user customization of the ticker 600 are possible. For instance, the viewer can customize a skin of the ticker 600 so that his favorite sports team's logos and colors decorate the text and borders of the ticker 600. Another skin for children can include modules that are decorated with cartoons. In one embodiment, 25-50 skins may be created by an interactive service provider (or other party) with preset collections of content modules with preset colors, fonts, borders, and so forth that viewers can select by scrolling through them. The viewer may pick anywhere from 3-5 content modules (or more or less), for instance, depending on what he wishes to view and what the display screen 402 can accommodate.

FIG. 14 illustrates an “L-bar” module 1400 for the ticker 600. The L-bar module, as its name implies, comprises a skin configured in a shape of the letter L, where the television program 404 occupies a region outside of the L-bar, while ticker information is presented within the L-bar. In an embodiment, the L-bar module 1400 includes one or more other modules, including a stock market module 1402, an email module 1404, and a sports module 1406 as examples. As depicted in FIG. 14, use of the L-bar configuration allows an aspect ratio of the television program 404 to be preserved, while making efficient use of the region of the display screen 402 around the television program image for presentation of ticker information.

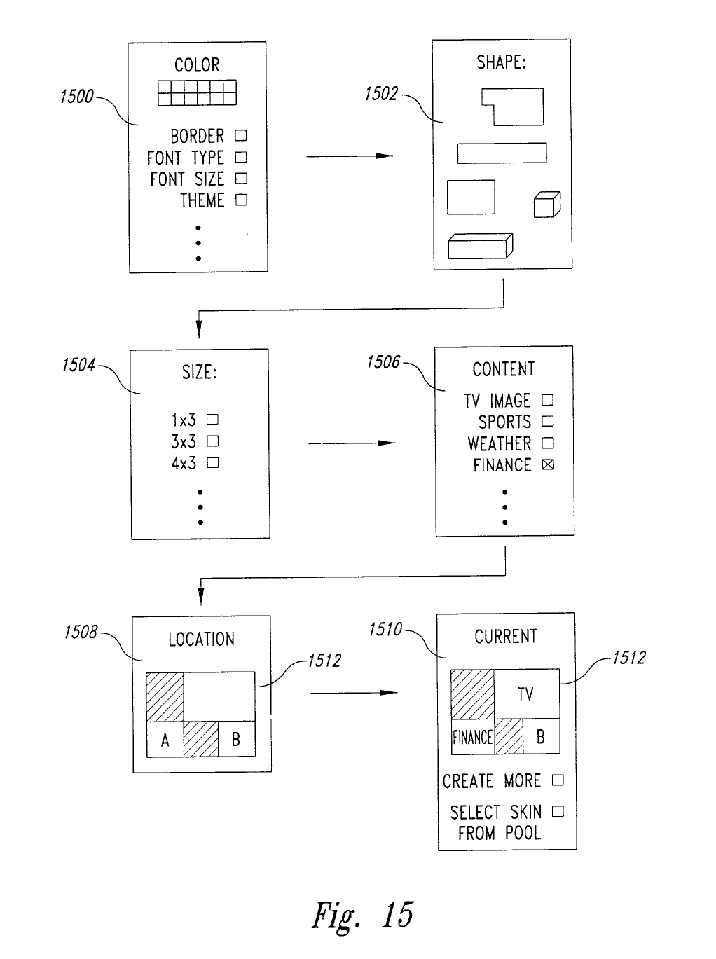

FIG. 15 are example user preferences screens that can be used to select and customize modules for the ticker 600 in accordance with an embodiment of the invention. It is to be appreciated that these preferences screens are merely illustrative of examples and that they need not necessarily be accessed in the exact order shown in FIG. 15. Moreover, some embodiments may use additional or fewer screens to achieve the desired degree of selection and customization of modules for the ticker 600.

The various preferences screens may be accessed from a menu, for instance, or via some other technique when the ticker 600 is initially invoked. Alternatively or in addition, the preferences screens may be accessed without necessarily invoking the ticker 600. Selections can be made from the screens by checking off selections boxes, dragging and dropping, scrolling or paging through sample skin selections and picking the ones that are desired, accessing a pool of skins from a source, and so forth. Beginning at a screen 1500, the viewer can select to customize appearance characteristics of one or more modules. Such appearance characteristics can include, but not be limited to, color, border, font type, font size, theme (e.g., space travel, cartoons, favorite sports team colors, etc.), and so on. The selections made in the screen 1500 can be applied to just one module, several modules, or universally to all modules.

Next at a screen 1502, the viewer can select the shape of a module. As shown, the various shapes can include tabbed modules, narrow modules, and three-dimensional modules. In one embodiment, the selections made at the screen 1500 can influence what shape choices are available at the screen 1502. For instance, if a particular font size selected from the screen 1500 does not display well with a narrow module, then the narrow module is not made available as a choice for the viewer in the screen 1502.

Next at a screen 1504, the viewer can select a size for the shape chosen from the screen 1502. In one embodiment, the selections made at the screen 1502 can influence what size choices are available at the screen 1504. For instance, if a particular shape selected from the screen 1502 does not physically match with one or more sizes, then such size(s) are not made available as a choice for the viewer in the screen 1504.

At a subsequent screen 1506, the viewer can select the content to be displayed for the module being customized. Examples of content include the image of the television program 404, sports, weather, finance, and so forth. As before, the choices made at the previous screens can influence the choices made at the screen 1506. For example, the image for the television program 404 may not be available as a choice in the screen 1506 if the prior shape and size choices made in the screens 1502 and 1504 are inconsistent with a 4:3 aspect ratio. In the screen 1506, “finance” is selected as the content for the current module.

A screen 1508 allows the viewer to select the location for the module, with the possible choices being designated as “A” or “B” in a layout 1512 for the display screen 402. The areas shown as cross hatching in the layout 1512 represent unavailable regions where selections have already been made, or where the current module's shape or size may be incompatible with the physical dimensions of that region.

A screen 1510 shows the current state of the layout 1512 after the viewer has selected “A” as the location for the finance module. The layout 1512 in the screen 1510 thus shows other regions where more modules can be added. Thus a “Create More” selection is available if the viewer wishes to customize and add more modules. Alternatively or in addition, a “Select Skin” selection is available in the screen 1510 (or from any of the previous screens) where the viewer can select from a pool of preset skins that may be made available by the interactive service provider or uploaded (and customized) by other individuals, where such skins may already have pre-defined sizes, colors, shapes, etc. so that the viewer need not necessarily customize (but can further customize, if desired) each and every one of these elements. Moreover, it is to be appreciated that any of the screens depicted in FIG. 15 can be accessed to revise or update a module that was previously customized. In such an embodiment, the modules are defined and then assigned with variables that can be altered.

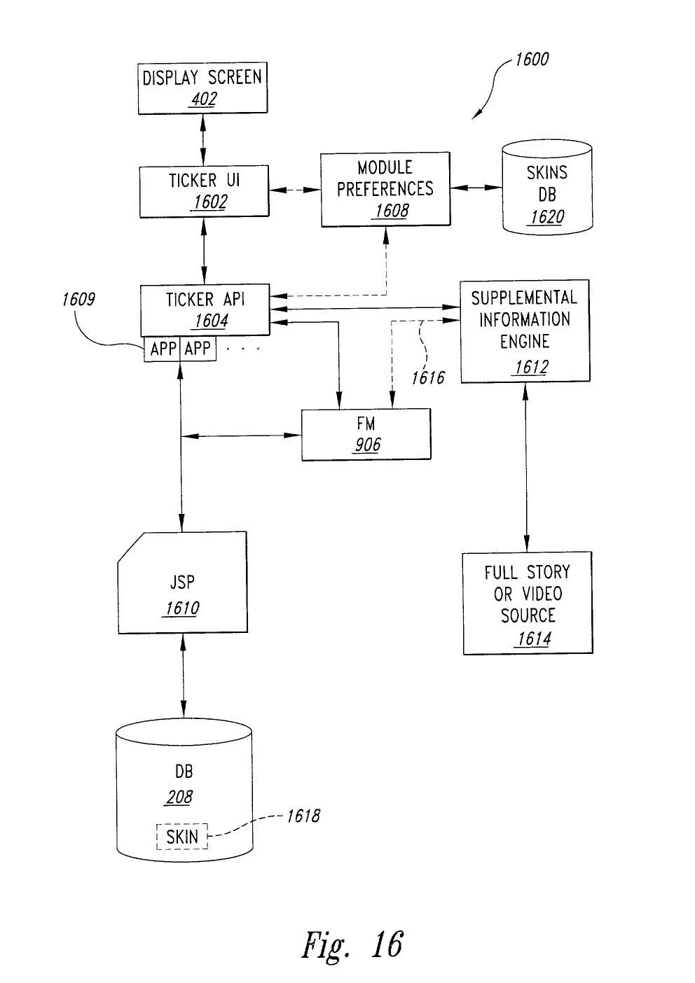

FIG. 16 is a flow block diagram 1600 illustrating components that can interact to present the module-based ticker 600 according to an embodiment of the invention, including operations associated with customizing its modules. At least some of the components of FIG. 16 can be embodied in software or other machine-readable instruction stored on a machine-readable medium, such as the storage medium 322. An embodiment of the ticker software includes a ticker user interface (UI) 1602 that presents the ticker 600 on the display screen 402, as well as being able to receive and process viewer responses related to customization of modules in embodiments where customization is performed through the ticker UI 1602. In another embodiment, customization of modules is performed by exiting the ticker UI 1602 and then entering a modules preferences component 1608 (as symbolically depicted by broken lines in FIG. 16), with the modules preferences component 1608 including the various preferences screens shown in FIG. 15.

A ticker application program interface (API) 1604 interacts with the ticker UI 1602 to control which module the ticker UI 1602 displays, how to display, when to display, where to display, and so forth. In an embodiment, the ticker API 1604 communicates with the module preferences component 1608 to obtain the customization information for the viewer-specified modules, and provides this information to the ticker UI 1602.

Also in an embodiment, the ticker API 1604 provides links, video, and other supplemental information to the ticker UI 1602, as well as processing user commands requesting supplemental information entered via the ticker UI 1602. Such supplemental information can be requested by the ticker API 1604 from a supplemental information engine 1612 (such as a browser in one embodiment), which in turn obtains the requested supplemental information from a full story or video source 1614. In one embodiment, a jsp component acts as a layer between all sources of data and the layers, such as the ticker API 1604 and supplemental information engine 1612 that massage data for the ticker UI 1602.

The ticker API 1604 interfaces with a plurality of module applications 1609. These module applications can include a sports application, news application, weather application, or other applications associated with modules that the ticker 600 can present to the viewer. In an embodiment, more than one ticker API 1604 may be present to interface with module applications 1609. A feed manager (FM) 1606 (or other software controller) operates to determine when new or updated ticker information is present and needs to be provided to the ticker API 1604. The feed manager 1606 can also communicate with the supplemental information engine 1612 (as symbolically depicted by a broken line 1616 in FIG. 16) to determine the availability of newly updated video highlights or full-content information that can be presented in any one of the modules.

To generally describe operation of the ticker 600 in an example embodiment, the ticker API 1604 logs and knows what the ticker 600 is displaying, and also knows how often the displayed information needs to be refreshed (based on business rules or other requirements present in functions defined in the ticker UI 1602). If it is time for an update, the ticker API 1604 (acting as a container of data) calls a load function that will cause the feed manager 1606 to loop through the module applications 1608 to search for new data, and if there is new data, the feed manager 1606 will pass the new data from the module application(s) 1609 to the ticker API 1604 so that the ticker API 1604 can pass the new data to the ticker UI 1602.

In another embodiment, the ticker API 1604 manages the information that the ticker UI 1602 will display, but it does not have knowledge of what the ticker UI 1602 displays and when it is displayed. The ticker UI 1602 invokes the lower level components via method calls to retrieve business objects. This means that the invocations of these lower levels are done potentially many times for each accessor/factory method to get a particular business object (assuming that there may be more than one business object needed to gather all data). There are at least two routes that the ticker UI 1602 can take in an embodiment.

First, the ticker UI 1602 invokes the feed manager 1606. This is done in situations when the business object contains some data that needs to be refreshed periodically during the session. The feed manager 1606 receives several arguments that tell it which method in the ticker API 1604 will return the business object, how frequently the feed manager 1606 should poll this business logic, and the name of the ticker UI variable (a collection such as an array) that holds the properties of the business object for the ticker UI 1602 components to use and display. The feed manager 1606 calls the ticker API 1604 immediately, and then at the intervals specified by the ticker UI 1602. Second, the ticker UI 1602 invokes the ticker API 1604 directly. This bypasses the feed manager 1606 and is done for data that only needs to be instantiated once during the session.

In one embodiment for the module-based ticker 600 where the feed manager 1606 (not the ticker API 1604) knows when it is time for an update, the process can be as follows. The ticker UI 1602 calls the ticker API 1604 to start a feed. The ticker API 1604 calls the feed manager 1606, and the feed manager 1606 constructs a callback object. The feed manager 1606 returns an empty object array to the ticker API 1604, which in turn returns the empty object array to the ticker UI 1602.

The feed manager 1606 calls an appropriate application 1609 for a business object, and the business object(s) is returned to the feed manager 1606 in an array, a copy of which is saved by the feed manager 1606 as a business object array. The feed manager 1606 returns the object array to the ticker U 11602 can calls a HandleLoad function, for instance.

At a particular interval, the feed manager 1606 calls an application 1609 for new information. The business objects are returned to the feed manager 1606 by the application 1609 in an array, and the feed manager 1606 checks that array with the saved array for different information. If the content has changed, then the feed manager 1606 returns an object array to the ticker UI 1602 and calls a HandleLoad function. The ticker UI 1602 calls the ticker API 1604 to stop a feed. The ticker API 1604 calls the feed manager 1606 to stop the feed, and the feed manager 1606 stops the feed.

To obtain such ticker data, in an embodiment, the module application(s) 1609 calls a Java server page (JSP) at a web server (which may be located at the distribution server 218). Java objects at the web server will then communicate with the database 208 to obtain the appropriate ticker information. The Java objects will then construct XML code from the ticker information obtained from the database 208, and send the XML code to the corresponding module application 1609. The module application 1609 then converts the XML code into object-oriented format, in one embodiment, and returns the object(s) to the ticker API 1604. The ticker API 1604 subsequently sends the object(s) to the ticker UI 1602 for display in the ticker 600.

As mentioned above for one of the embodiments, the viewer can generate customized skins by exiting the ticker UI 1602 and accessing the preferences screens of the module preferences component 1608 (or other back-end tool). The module preferences component 1608 is communicatively linked to access a skins database 1620 that provides preset/default skins, stores skin templates that can be accessed and selected by the viewer when customizing modules, the viewer's specific skin selections or customized skins, customized skins created by other individuals and uploaded to the skins database 1620, and so forth. This skin information can be passed between the module preferences component 1608 and the ticker UI 1602 or ticker API 1604 as objects, according to one embodiment. The skins database 1620 can comprise any suitable source of skins, including local storage, a server, web site, a channel carousel broadcasting skins, and others.

Another example of a technique to generate customized skins is to have the ticker UI 1602 call the ticker API 1604, such as in a situation when the viewer wishes to customize a sports module or skin. The ticker API 1604 then calls a sports application from among the applications 1609. The sports application subsequently calls the database 208 (via the JSP 1610) to select or retrieve skin customization information 1618 stored in the database 208 or in some other skin source. The skin information (including formatting and other customization information) is returned to the sports application, converted to an object or objects, and passed to the ticker API 1604. From this information, the ticker API 1604 can provide instructions to the ticker UI 1602 as to how to present the module. Examples of skin information that can be placed in one or more objects that can be passed to the ticker UI 1602 include, but are not limited to, size, shape, color, text, number of sides for a three-dimensional module, border, font, content type, and others.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

As an example, a satellite television (TV) delivery system may be implemented alternatively or in addition to a cable distribution system. A satellite TV delivery system may comprise a direct broadcast satellite (DBS) system. A DBS system may comprise a small 18-inch satellite dish (which is an antenna for receiving a satellite broadcast signal); a digital integrated receiver/decoder (IRD), which separates each channel, and decompresses and translates the digital signal so a television can show it; and a remote control. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A digital broadcast center (e.g., analogous to the head-end 106) may be used to gather programming content, ensure its digital quality, and transmit the signal up to the satellites. Programming may come to the broadcast center from content providers (TBS™, HBO™, CNN™, ESPN™, etc.) via satellite, fiber optic cable, and/or special digital tape. Satellite-delivered programming is typically immediately digitized, encrypted and uplinked to the orbiting satellites. The satellites retransmit the signal back down to every earth-station—or, in other words, every compatible DBS system receiver dish at customers' homes and businesses.

Some programs may be recorded on digital videotape in the broadcast center to be broadcast later. Before any recorded programs are viewed by customers, technicians may use post-production equipment to view and analyze each tape to ensure audio and video quality. Tapes may then be loaded into a robotic tape handling system, and playback may be triggered by a computerized signal sent from a broadcast automation system. Back-up videotape playback equipment may ensure uninterrupted transmission when appropriate.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
receiving ticker data from a video casting system;
presenting the ticker data as a plurality of items of a ticker located on a first region of a display screen while a video image is displayed on a second region of the display screen; and
arranging the presentation of the plurality of items of the ticker into corresponding modules that fit within the first region of the display screen, based on user customization of a shape and size of the modules.

2. The method of claim 1, further comprising arranging presentation of the modules in the first region based on user customization of an appearance characteristic of the modules.

3. The method of claim 2 wherein the appearance characteristics of the modules include at least one of a color, border, font type, font size, and theme.

4. The method of claim 1 wherein at least one of the modules has a user-selectable three-dimensional shape with a plurality of surfaces, the method further comprising:
presenting at least one of the plurality of items in one of the surfaces of the three-dimensional shape; and
rotating the three-dimensional shape to present another one of the plurality of items in another surface of the three-dimensional shape.

5. The method of claim 1, further comprising presenting a theme that is common to all modules of the ticker, based on user-customization.

6. The method of claim 1, further comprising presenting items of different subject matter topics in the modules, based on user-customization of a subject matter topic to be presented in a respective module.

7. The method of claim 6 wherein one of the subject matter topics include at least one of a sports, news, weather, finance, travel, email, traffic, television program, movies, interactive game, and stock market.

8. The method of claim 6, further comprising, for least some of the modules, concurrently scrolling items presented therein.

9. The method of claim 6, further comprising, for least some of the modules, scrolling items presented therein only if an update to such items becomes available.

10. The method of claim 1 wherein a user-selectable shape of one of the modules comprises an L-bar shape configured to fit within the first region of the display screen.

11. The method of claim 1, further comprising proving at least one user preference screen to allow user customization of the modules.

12. The method of claim 11, further comprising providing the user preference screen as a screen among a plurality of screens, wherein user customization performed on one screen determines availability of customization selections in another screen, including location and size of a module to be customized.

13. The method of claim 1 wherein at least some of the modules are selectable from a storage location that stores preset modules, including graphical skins for the modules.

14. An article of manufacture, comprising:
a machine-readable medium having instructions stored thereon to:
present ticker data, received from an interactive video casting system, as a plurality of items of a ticker located on a first region of a display screen while a video image is displayed on a second region of the display screen; and
arrange the presentation of the plurality of items of the ticker into corresponding modules that fit within the first region of the display screen, based on user customization of a shape and size of the modules.

15. The article of manufacture of claim 14 wherein the machine-readable medium further includes instructions stored thereon to arrange presentation of the modules in the first region based on user customization of an appearance characteristic of the modules.

16. The article of manufacture of claim 14 wherein at least one of the modules has a user-selectable three-dimensional shape with a plurality of surfaces, the machine-readable medium further including instructions stored thereon to:
present at least one of the plurality of items in one of the surfaces of the three-dimensional shape; and
rotate the three-dimensional shape to present another one of the plurality of items in another surface of the three-dimensional shape.

17. The article of manufacture of claim 14 wherein the machine-readable medium further includes instructions stored thereon to present items of different subject matter topics in the modules, based on user-customization of a subject matter topic to be presented in a respective module.

18. The article of manufacture of claim 17 wherein the instructions to present items of different subject matter topics in the modules include instructions to concurrently scroll items presented therein.

19. The article of manufacture of claim 14 wherein the machine-readable medium further includes instructions stored thereon to generate at least one user preference screen to allow user customization of the modules.

20. The article of manufacture of claim 19 wherein the instructions to generate the user preference screen include instructions to provide the user preference screen as a screen among a plurality of screens, wherein user customization performed on one screen determines availability of customization selections in another screen, including location and size of a module to be customized.

21. An apparatus, comprising:
a means for receiving ticker data from a video casting system;
a means for presenting the ticker data as a plurality of items of a ticker located on a first region of a display screen while a video image is displayed on a second region of the display screen; and
a means for arranging the presentation of the plurality of items of the ticker into corresponding modules that fit within the first region of the display screen, based on user customization of a shape and size of the modules.

22. The apparatus of claim 21 wherein the means for arranging the presentation of the plurality of items of the ticker into corresponding modules that fit within the first region of the display screen includes at least one user preferences screen.

23. The apparatus of claim 21 wherein the means for arranging the presentation of the plurality of items of the ticker into corresponding modules that fit within the first region of the display screen include includes a means for selecting from a plurality of preset graphical skins for the modules.

24. A ticker for a video casting system, the ticker comprising:
a plurality of modules, each module operative to present different ticker data determined based on user customization,
wherein the modules have a shape and size determined based on user customization, the shape and size of the modules being configured according to the user customization to fit within a first region of a display screen, concurrently with a second region of the display screen capable to present a video image.

25. The ticker of claim 24 wherein the modules further have an appearance characteristic determined based on user customization.

26. The ticker of claim 24 wherein at least some of the ticker data is linked to supplemental information.

27. The ticker of claim 24 wherein at least some of the modules are operative to concurrently scroll ticker data presented therein.

28. The ticker of claim 24 wherein at least some of the modules are capable to be modified, including addition or deletion of a module based on user customization.

29. The ticker of claim 24 wherein at least one of the modules has a three-dimensional shape, wherein rotation of the three-dimensional shape results in presentation of a surface that has ticker data present thereon.

30. The ticker of claim 24, further comprising:
a ticker user interface (UI) to generate the modules presented in the first region of the display screen;
a ticker application program interface (API) in communication with the ticker (UI) to control presentation of ticker data in their respective modules; and
a feed manager in communication with the video casting system and with the ticker API to control transmission of ticker data, associated with the modules, from the video casting system to the ticker API.

31. The ticker of claim 30 wherein configuration information for the modules is obtained from a skins source.

32. The ticker of claim 30, further comprising an application associated with each module, wherein the application operates in conjunction with the ticker API to determine presentation of ticker data through its respective module.

33. The ticker of claim 24, further comprising at least one user preference screen to allow user customization of the modules, wherein user customization performed on one screen determines availability of customization selections in another screen, including location and size of a module to be customized.

34. An apparatus for a video casting system, the apparatus comprising:
at least one communication interface to receive ticker data sent from the video casting system;
a storage medium coupled to the communication interface to store a ticker software program;
a processor, coupled to the storage medium and to the communication interface, to cooperate with the ticker software program to process the ticker data; and
an output section to provide the processed ticker data to a display screen capable to present the ticker data through a ticker having a plurality of user-customizable modules specified by the ticker software program, the modules having a size and shape based on user customization implemented by the ticker software program to fit within a first region of the display screen concurrently with a video image displayed within a second region of the display screen.

35. The apparatus of claim 34 wherein the ticker software program comprises:
a ticker user interface (UI) to generate the modules presented in the first region of the display screen;
a ticker application program interface (API) in communication with the ticker (UI) to control presentation of ticker data in their respective modules, and to obtain user customization data associated with the modules and to control presentation of modules by the ticker UI based on the user customization data; and
a feed manager in communication with the video casting system and with the ticker API to control transmission of ticker data, associated with the modules, from the video casting system to the ticker API.

36. The apparatus of claim 34 wherein the ticker software program includes code to generate at least one of the modules with a three-dimensional shape having a plurality of surfaces, and to rotate the three-dimensional shape within the ticker in a manner that different ticker data is presented on each surface after rotation.

37. The apparatus of claim 34 wherein the ticker software program includes code to generate at least one preference screen through which user customization of the modules can be made, wherein user customization performed in one screen controls availability of user customization in another screen.

38. A video casting system, comprising:
a source of skins data;
a source of ticker data; and
an apparatus coupled to the source, the apparatus including:
at least one communication interface to receive ticker data sent from the source of ticker data;
a storage medium coupled to the communication interface to store a ticker software program;
a processor, coupled to the storage medium and to the communication interface, to cooperate with the ticker software program to process the ticker data; and
an output section to provide the processed ticker data to a display screen capable to present the ticker data through a ticker having a plurality of user-customizable modules specified by the ticker software program, the modules having a size and shape available from the source of skins data and based on user customization implemented by the ticker software program in a manner to fit within a first region of the display screen concurrently with a video image displayed within a second region of the display screen.

39. The system of claim 38 wherein the source of skins data comprises a server having the skins data uploaded thereon.

40. The system of claim 38 wherein the source of skins data comprises a local storage location coupled to the apparatus.

41. The system of claim 38 wherein the ticker software program includes code to generate at least one of the modules with a three-dimensional shape having a plurality of surfaces, and to rotate the three-dimensional shape within the ticker in a manner that different ticker data is presented on each surface after rotation.

42. The system of claim 38 wherein the source of the data comprises:
a feed server to receive a plurality of feeds of ticker data and having a feed engine to manipulate the ticker data received from the feeds;
a production server coupled to the feed server to receive the ticker data manipulated by the feed engine, and coupled to a database having tables for the manipulated ticker data received from the feed server, the production server being capable to change a format of the manipulated ticker data to a format compatible with client terminals configured to present the screen interface on the display screen; and
a distribution server to send the manipulated ticker data having the format compatible with the client terminals.

43. A method usable in a video casting system, the method comprising:
receiving ticker data from a video casting system,
wherein a client terminal for a television for the video casting system is coupled to present the received ticker data, through a ticker located on a first region of a display screen of the television,
wherein the video casting system includes a plurality of sources, which provide the ticker data, communicatively coupled to a plurality of broadcast centers,
wherein at least one of the broadcast centers is coupled to a server capable to provide the data from the sources to the client terminal, and
wherein the video casting system is capable to provide the ticker data to the client terminal via different communication channels, including at least one of a plurality of television broadcast channels, an out-of-band channel, and a communication channel with a communication network;
presenting the ticker data as a plurality of items of the ticker located on the first region of the display screen while a video image is displayed on a second region of the display screen; and
arranging the presentation of the plurality of items of the ticker into corresponding modules that fit within the first region of the display screen, based on user customization of a shape and size of the modules, the modules further having an appearance characteristic including at least one of a border, font, font size, color, and theme.

44. The method of claim 43, further comprising presenting concurrently scrolling different ticker items in at least some of the modules.

45. The method of claim 43, further comprising providing at least one preference screen through which the user customization can be performed.

46. A video casting system, comprising:
a source of ticker data including:
a feed server to receive a plurality of feeds of ticker data and having a feed engine to manipulate the ticker data received from the feeds;
a production server coupled to the feed server to receive the ticker data manipulated by the feed engine, and coupled to a database having tables for the manipulated ticker data received from the feed server, the production server being capable to change a format of the manipulated ticker data to a format compatible with client terminals configured to present a screen interface on a display screen; and
a distribution server to send the manipulated ticker data having the format compatible with the client terminals; and
an apparatus coupled to the distribution server of the source, the apparatus including:
at least one communication interface to receive ticker data sent from the source of ticker data;
a storage medium coupled to the communication interface to store a ticker software program;
a processor, coupled to the storage medium and to the communication interface, to cooperate with the ticker software program to process the ticker data; and
an output section to provide the processed ticker data to a display screen capable to present the ticker data through a ticker having a plurality of user-customizable modules specified by the ticker software program, the modules having a size and shape available from the source of skins data and based on user customization implemented by the ticker software program in a manner to fit within a first region of the display screen concurrently with a video image displayed within a second region of the display screen, wherein at least one of the modules has a three-dimensional shape with a plurality of surfaces, the ticker software program including code to rotate the three-dimensional shape within the ticker in a manner that different ticker data is presented on each surface after rotation.

47. The system of claim 46 wherein the video image is provided by way of a satellite television delivery system.

48. The system of claim 46 wherein the ticker is provided by way of an interactive television system.

49. The system of claim 46 wherein the ticker software program includes code to generate the ticker based on a Flash program.
